(19) United States
(12) Patent Application Publication
(10) Pub. No.: US 2008/0121821 A1
(43) Pub. Date: May 29, 2008

(54) TECHNIQUES FOR LOW-TEMPERATURE ION IMPLANTATION

(75) Inventors: Richard Stephen Muka, Topsfield, MA (US); Christopher Andreas Rowland, Rockport, MA (US); Jonathan Gerald England, Horsham (GB)

Correspondence Address: HUNTON & WILLIAMS LLP/VARIAN SEMICONDUCTOR,;EQUIPMENT ASSOCIATES, INC., INTELLECTUAL PROPERTY DEPARTMENT, 1900 K STREET, N.W., SUITE 1200, WASHINGTON, DC, 20006-1109, US

(73) Assignee: Varian Semiconductor Equipment Associates Inc., Gloucester, MA (US)

(21) Appl. No.: 11/696,506

(22) Filed: Apr. 4, 2007

Related U.S. Application Data
(60) Provisional application No. 60/861,160, filed on Nov. 27, 2006.

(51) Int. Cl. G21K 5/10; F28F 7/00

(52) U.S. Cl. 250/492.21; 165/80.4; 165/80.1

(57) ABSTRACT

Techniques for low-temperature ion implantation are disclosed. In one particular exemplary embodiment, the techniques may be realized as a wafer support assembly for low-temperature ion implantation. The wafer support assembly may comprise a base. The wafer support assembly may also comprise a platen configured to mount to the base via one or more low-thermal-contact members, wherein the platen has a heat capacity larger than that of a wafer mounted thereon, such that, if pre-chilled to a predetermined temperature, the platen causes the wafer to stay within a range of the predetermined temperature during ion implantation.

### CROSS-REFERENCE TO RELATED APPLICATIONS

This patent application claims priority to U.S. Provisional Patent Application No. 60/861,160, filed Nov. 27, 2006, which is hereby incorporated by reference herein in its entirety.

This patent application is related to U.S. patent application Ser. No. 11/504,367, filed Aug. 15, 2006, which is hereby incorporated by reference herein in its entirety.

### FIELD OF THE DISCLOSURE

The present disclosure relates generally to semiconductor manufacturing and, more particularly, to techniques for low-temperature ion implantation.

### BACKGROUND OF THE DISCLOSURE

With continued miniaturization of semiconductor devices, there has been an increased demand for ultra-shallow junctions. For example, tremendous effort has been devoted to creating better activated, shallower, and more abrupt source-drain extension junctions to meet the needs of modern complementary metal-oxide-semiconductor (CMOS) devices.

To create an abrupt, ultra-shallow junction in a crystalline silicon wafer, for example, amorphization of the wafer surface is desirable. Generally, a relatively thick amorphous silicon layer is preferred because fewer interstitials from the ion implant will remain after a solid-phase epitaxial growth as part of a post-implant anneal. A thin amorphous layer can lead to more interstitials residing in an end-of-range area beyond the amorphous-crystalline interface. These interstitials may lead to transient enhanced diffusion (TED) of ion-implanted dopants, causing a resultant dopant profile (e.g., P-N or N-P junction) to deepen and/or lose a desired abruptness. As a result, a thinner amorphous layer can adversely increase short channel effects in electronic devices. The interstitials may also lead to the formation of inactive clusters which, particularly in the case of boron, can reduce dopant activation. The interstitials beyond the amorphous-crystalline interface not removed during the activation anneal may combine to form complex end-of-range damage. This damage can lead to junction leakage and yield loss mechanisms. The damage may evolve during later thermal processes by emitting interstitials which can lead to further dopant diffusion and dopant deactivation.

It has been discovered that a relatively low wafer temperature during ion implantation is advantageous for amorphization of a silicon wafer. In current applications of ion implantation, wafers are typically cooled during the implantation process by a gas-assisted process using a water chiller. In most cases, such cooling techniques put the wafer temperature between the chiller temperature (e.g., 15° C.) and a higher temperature having an upper limit imposed to preserve photoresist integrity (e.g., 100° C.). Such a higher temperature may enhance a self-annealing effect, i.e., the annihilation (during the implant) of Frenkel pairs (vacancy-interstitial pairs created from ion beam bombardments). Since amorphization of the silicon occurs only when a sufficient number of silicon atoms are displaced by beam ions, the increase of Frenkel pair annihilation at high temperatures works against the much needed amorphization process, resulting in a higher dose threshold for amorphization and therefore less than ideal shallow junctions.

With other parameters being the same, the thickness of an amorphous silicon layer may increase with decreasing implantation temperature due to a reduction of the self-annealing effect. Thus, better process control and prediction of device performance may be achieved.

Rapid thermal anneals, in which the wafer is heated to, for example, 1000° C. in 5 seconds, have commonly been used to activate implanted dopants. Diffusion-less anneals are becoming preferred post-implant processes, wherein the temperature of a wafer is ramped up much faster (e.g., to 1000° C. in 5 milliseconds) using, for example, a laser or flash lamps, as a heat source. These extremely rapid thermal processes act so quickly that the dopants do not have time to diffuse significantly, but there is also less time for the implant damage to be repaired. It is believed that low-temperature ion implantation may improve the extent of implant damage repair during such diffusion-less anneals.

Other reasons for low-temperature ion implantation also exist.

Although low-temperature ion implantation has been attempted, existing approaches suffer from a number of deficiencies. For example, low-temperature ion implantation techniques have been developed for batch-wafer ion implanters while the current trend in the semiconductor industry favors single-wafer ion implanters. Batch-wafer ion implanters typically process multiple wafers (batches) housed in a single vacuum chamber. The simultaneous presence of several chilled wafers in the same vacuum chamber, often for an extended period of time, requires extraordinary in-situ cooling capability. Pre-chilling an entire batch of wafers is not an easy option since each wafer will experience a different temperature increase while waiting for its turn to be implanted. In addition, extended exposure of the vacuum chamber to the low-temperature wafers may result in icing from residual moisture.

Also, almost all existing low-temperature ion implanters cool wafers directly during ion implantation. Apart from causing icing problems in a process chamber, direct cooling requires incorporation of cooling components (e.g., coolant pipelines, heat pumps, and additional electrical wirings) into a wafer platen. Usually, modern wafer platens are already fairly sophisticated and highly optimized for room-temperature processing. As a result, modification of an existing ion implanter or designing a new ion implanter to accommodate low-temperature processes can be complicated and may have unwanted impact on the ion implanter's capability of performing room temperature ion implantation processes.

In view of the foregoing, it would be desirable to provide a solution for low-temperature ion implantation which overcomes the above-described inadequacies and shortcomings.

### SUMMARY OF THE DISCLOSURE

Techniques for low-temperature ion implantation are disclosed. In one particular exemplary embodiment, the techniques may be realized as a wafer support assembly for low-temperature ion implantation. The wafer support assembly may comprise a base. The wafer support assembly may also comprise a platen configured to mount to the base via one or more low-thermal-contact members, wherein the platen has a heat capacity larger than that of a wafer mounted thereon, such that, if pre-chilled to a predetermined temperature, the platen causes the wafer to stay within a range of the predetermined temperature during ion implantation.

In accordance with other aspects of this particular exemplary embodiment, the platen may comprise a thermal reservoir containing one or more coolants with a desired mass and heat capacity. The one or more coolants may comprise a phase-change material that maintains a constant temperature during a phase change. The platen may further comprise an electrostatic clamp to secure the wafer onto the platen. The platen may further comprise a gas break, and wherein a gas pressure within the gas break may be adjustable to change a thermal conductivity between the platen and the wafer. The wafer may be monitored for temperature changes and the gas pressure within the gas break may be adjusted to keep the wafer within a desired temperature range.

In accordance with further aspects of this particular exemplary embodiment, the platen may further comprise cooling channels through which one or more coolants are circulated to cool the platen.

In accordance with additional aspects of this particular exemplary embodiment, the wafer support assembly may further comprise a mechanism to bring a pre-chilled chuck into thermal contact with the platen to cool the platen.

In accordance with another aspect of this particular exemplary embodiment, the wafer support assembly may further comprise a mechanism to bring a cooling loop into thermal contact with the platen to cool the platen.

In accordance with yet another aspect of this particular exemplary embodiment, the wafer may be pre-chilled together with the platen to the predetermined temperature.

In another particular exemplary embodiment, the techniques may be realized as a method for low-temperature ion implantation. The method may comprise pre-chilling a platen to a predetermined temperature. The method may also comprise mounting a wafer onto the pre-chilled platen, wherein the pre-chilled platen has a heat capacity larger than that of the wafer. The method may further comprise performing ion implantation on the wafer, wherein the pre-chilled platen causes the wafer to remain within a range of the predetermined temperature.

In accordance with other aspects of this particular exemplary embodiment, the method may further comprise pre-chilling one or more coolants in a thermal reservoir located within the platen. The method may also comprise pre-chilling a phase-change material in the thermal reservoir such that the wafer is maintained at an iso-thermal temperature during ion implantation.

In accordance with further aspects of this particular exemplary embodiment, the platen may further comprise a gas break, and the method may further comprise adjusting a gas pressure within the gas break to change a thermal conductivity between the platen and the wafer.

In accordance with additional aspects of this particular exemplary embodiment, the platen may be pre-chilled by circulating one or more coolants through cooling channels in the platen.

In accordance with another aspect of this particular exemplary embodiment, the wafer may be continuously cooled by circulating one or more coolants through cooling channels in the platen.

In accordance with yet another aspect of this particular exemplary embodiment, the method may further comprise bringing a pre-chilled chuck into thermal contact with the platen to cool the platen.

In accordance with still another aspect of this particular exemplary embodiment, the method may further comprise bringing a cooling loop into thermal contact with the platen to cool the platen.

In accordance with a further aspect of this particular exemplary embodiment, the method may further comprise pre-chilling the wafer together with the platen to the predetermined temperature.

In accordance with a yet further aspect of this particular exemplary embodiment, the method may further comprise the steps of pausing the ion implantation, pre-chilling the platen, and resuming the ion implantation on the wafer.

In yet another particular exemplary embodiment, the techniques may be realized as a wafer support assembly for wafer temperature control during ion implantation. The wafer support assembly may comprise a base. The wafer support assembly may also comprise a platen configured to mount to the base via one or more low-thermal-contact members, wherein the platen has a heat capacity larger than that of a wafer mounted thereon, such that, if pre-conditioned to a predetermined temperature, the platen causes the wafer to stay within a range of the predetermined temperature during ion implantation.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 shows a traditional ion implanter.

FIG. 2 shows a flow chart illustrating an exemplary method for low-temperature ion implantation in accordance with an embodiment of the present disclosure.

FIG. 3 shows a block diagram illustrating an exemplary wafer support assembly in accordance with an embodiment of the present disclosure.

FIG. 4 shows a block diagram illustrating an exemplary method for pre-chilling a platen in accordance with an embodiment of the present disclosure.

FIG. 5 shows a block diagram illustrating another exemplary method for pre-chilling a platen in accordance with an embodiment of the present disclosure.

FIG. 6 shows a block diagram illustrating yet another exemplary method for pre-chilling a platen in accordance with an embodiment of the present disclosure.

### DETAILED DESCRIPTION OF EXEMPLARY EMBODIMENTS

Embodiments of the present invention provide techniques for low-temperature ion implantation wherein a pre-chilled platen may be used to support a target wafer during ion implantation. The platen may have a larger heat capacity than that of the target wafer, and the platen may be thermally insulated from other ion implanter components. As a result, the wafer temperature may be maintained within a desired temperature range during ion implantation.

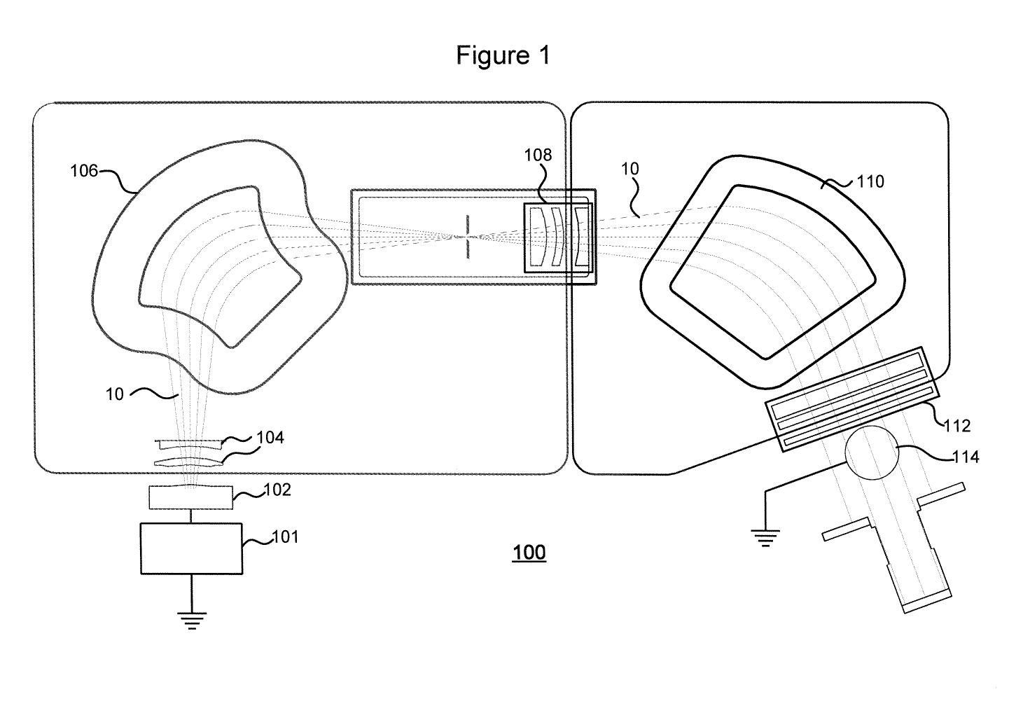

FIG. 1 depicts a traditional ion implanter system 100 in which a technique for low-temperature ion implantation may be implemented in accordance with an embodiment of the present disclosure. As is typical for most ion implanter systems, the system 100 is housed in a high-vacuum environment. The ion implanter system 100 may comprise an ion source 102, biased to a potential by power supply 101, and a complex series of beam-line components through which an ion beam 10 passes. The series of beam-line components may include, for example, extraction electrodes 104, a 90° magnet analyzer 106, a first deceleration (D1) stage 108, a 70° magnet collimator 110, and a second deceleration (D2) stage 112. Much like a series of optical lenses that manipulate a light beam, the beam-line components can filter and focus the ion beam 10 before steering it towards a target wafer. During ion implantation, the target wafer is typically mounted on a platen 114 that can be moved in one or more dimensions (e.g., translate, rotate, and tilt) by an apparatus, sometimes referred to as a “roplat.”

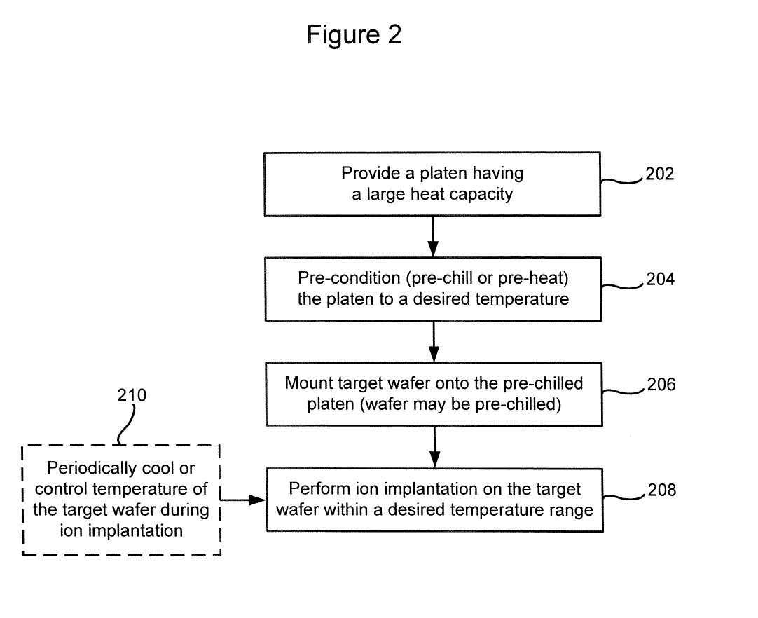

FIG. 2 shows a flow chart illustrating an exemplary method for low-temperature ion implantation in accordance with an embodiment of the present disclosure.

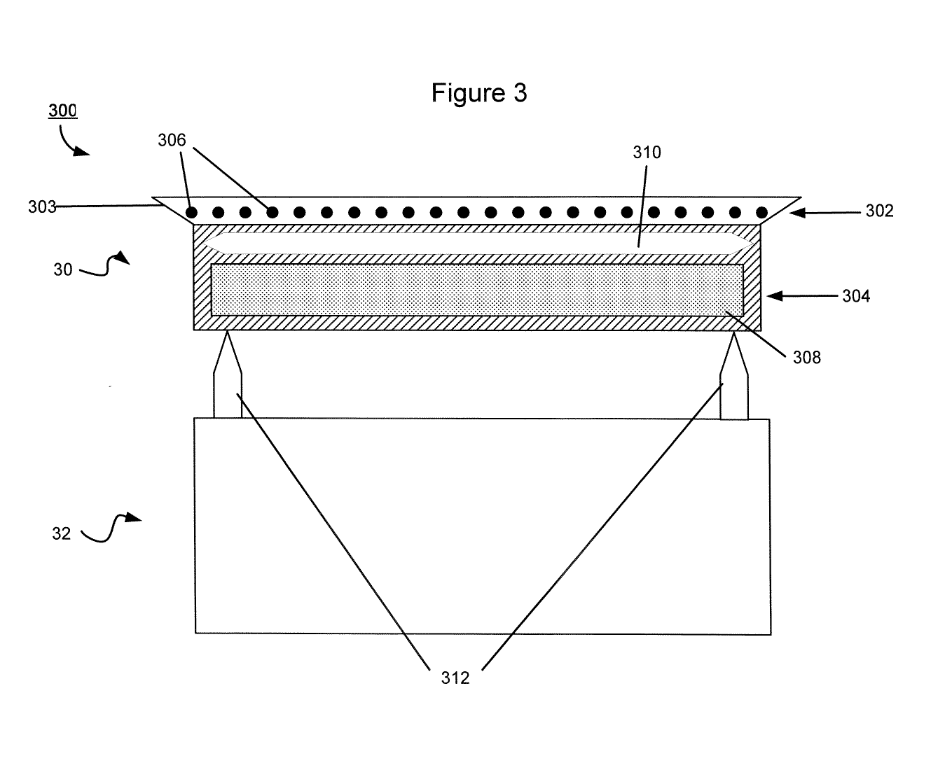

In step 202, a platen having a large heat capacity may be provided in an ion implanter. That is, at least a portion of the platen that will be in thermal contact with a target wafer may require a large amount of heat in order for its temperature to rise by a significant amount. Preferably, the heat capacity of the platen is substantially larger than that of the target wafer. That is, for the same amount of temperature increase, the platen will have to absorb much more heat than the target wafer. Exemplary designs of the platen will be described in detail below in connection with FIGS. 3-5.

In step 204, the platen may be pre-conditioned (pre-chilled or pre-heated) to a desired temperature. Prior to the initiation of a low-temperature ion implantation, the platen may be cooled to a temperature substantially lower than room temperature. The high-heat-capacity platen may also be useful for ion implantation processes at other temperature ranges. For example, some semiconductor manufacture applications may require a relatively high temperature or a precisely controlled temperature (or temperature range) during ion implantation. For these applications, the platen may be pre-conditioned to a predetermined temperature according to a desired ion implantation temperature or temperature range specified for the target wafer. The platen may be pre-conditioned to the desired temperature and then positioned in a wafer end-station. Preferably, the platen may be pre-conditioned in situ, that is, in the same position as it will be during ion implantation.

In step 206, the target wafer may be mounted onto the pre-conditioned platen. The target wafer may be preferably pre-conditioned to a same or similar temperature as the platen. Exemplary techniques for pre-cooling or pre-heating a wafer prior to ion implantation are described in U.S. patent application Ser. No. 11/504,367, which is hereby incorporated by reference herein in its entirety. The target wafer may be placed in direct thermal contact with the platen such that the target wafer and the platen form a large thermal mass. The platen may otherwise be thermally insulated from other components in the ion implanter.

In step 208, ion implantation may be performed on the target wafer. During the ion implantation, the target wafer may absorb energy from an ion beam. The amount of beam energy absorbed may normally heat up the target wafer by several degrees. However, due to the thermal contact between the target wafer and the platen, a substantial portion of the beam energy may be absorbed by the platen whose large heat capacity will tend to stabilize the temperature of the target wafer. As a result, the target wafer may experience only a limited temperature increase and may remain within a desired temperature range during the ion implantation.

Optionally, in step 210, the target wafer, mounted on the pre-conditioned platen, may be periodically cooled or have its temperature controlled during the ion implantation. Typically, if the platen has a sufficiently large heat capacity and has been properly isolated, the expected temperature increase of the target wafer may be small enough to require no continuous cooling. For some ion implantation recipes, especially with a large ion dose and/or an extended implant time, periodic pre-cooling may be desirable. That is, when the wafer temperature is expected to go out of a desired range, the ion implantation may be paused and the platen (and/or the target wafer) may be pre-cooled before the ion implantation is resumed.

FIG. 3 shows a block diagram illustrating an exemplary wafer support assembly 300 in accordance with an embodiment of the present disclosure. The wafer support assembly 300 may be part of a rotatable platen system located in a wafer end-station (not shown). The wafer support assembly 300 may comprise a platen 30 and a base 32. The platen 30 may be mounted on the base 32 via one or more low-thermal-contact members 312.

The platen 30 may have a large heat capacity and may be configured to support a target wafer during ion implantation. According to one embodiment of the present disclosure, the platen 30 may comprise two portions, a top portion 302 and a bottom portion 304.

The top portion 302 may include electrodes and dielectric layers (not shown) associated with an electrostatic clamp (ESC) deposited on top of a mechanical support base 303. The top portion 302 may be a single piece of material comprising, for example, insulating ceramic, or may be composed of several parts made from different materials. Cooling channels 306 may be embedded in the mechanical support base 303.

The bottom portion 304 may include a thermal reservoir 308 which may be made of or contain one or more materials chosen to provide a large heat capacity and/or other desired thermal characteristics. According to one embodiment, a phase-change material may be incorporated into the thermal reservoir 308. The phase-change material may change from one phase (e.g., liquid) to another (e.g., solid) when it is cooled to a sufficiently low temperature. When it warms up, the phase-change material may absorb a large amount of energy as latent heat and may maintain a relatively constant temperature during a reverse phase change. That is, the phase-change material may act as an iso-thermal control element, and therefore the phase-change material may be chosen according to a desired iso-thermal temperature. One example of such phase-change materials is pure water, although the volume change during liquid-to-solid transition may need to be taken to account. A mixture of water with varying amounts of anti-freeze is another example of materials that can be incorporated into the thermal reservoir 308. Other suitable materials are described in U.S. Pat. No. 6,686,598, which are hereby incorporated by reference herein by its entirety.

Prior to ion implantation, the platen 30 may be cooled down to a predetermined temperature by circulating a coolant through the cooling channels 306. Then, the coolant may be purged from the cooling channels 306, and a target wafer (not shown) may be mounted onto the platen 30 for ion implantation. Since the ion implantation takes place in a vacuum chamber (i.e., a wafer end-station) and the platen 30 has a limited thermal contact with the base 32, the combined thermal mass of the platen 30 and the target wafer is in effect thermally isolated. During the ion implantation, the only significant heat transfer to this thermal mass is from an ion beam because radiant heating may be ignored at low temperatures and the thermal conduction through the low-thermal-contact members 312 is designed to be small. With a known ion implant recipe, it may be estimated as to how much beam energy will be absorbed by the target wafer to contribute to its temperature increase. A properly configured platen 30 may then reduce that expected temperature increase by a substantial amount.

According to some embodiments of the present disclosure, a gas break 310 may be provided in the platen 30 between the top portion 302 and the bottom portion 304. The gas break 310 may comprise a chamber in which a gas pressure can be adjusted to change a thermal conductivity between the top portion 302 and the bottom portion 304 of the platen 30. The variable thermal conductivity allows a target wafer mounted on the platen 30 to be at a different temperature than the thermal reservoir 308. The wafer/platen temperature may be measured directly with devices such as thermal cups or pyrometers, or the top portion 302 may have a thermal cup embedded therein, and the temperature measurement signal may be used as feedback to control the temperature.

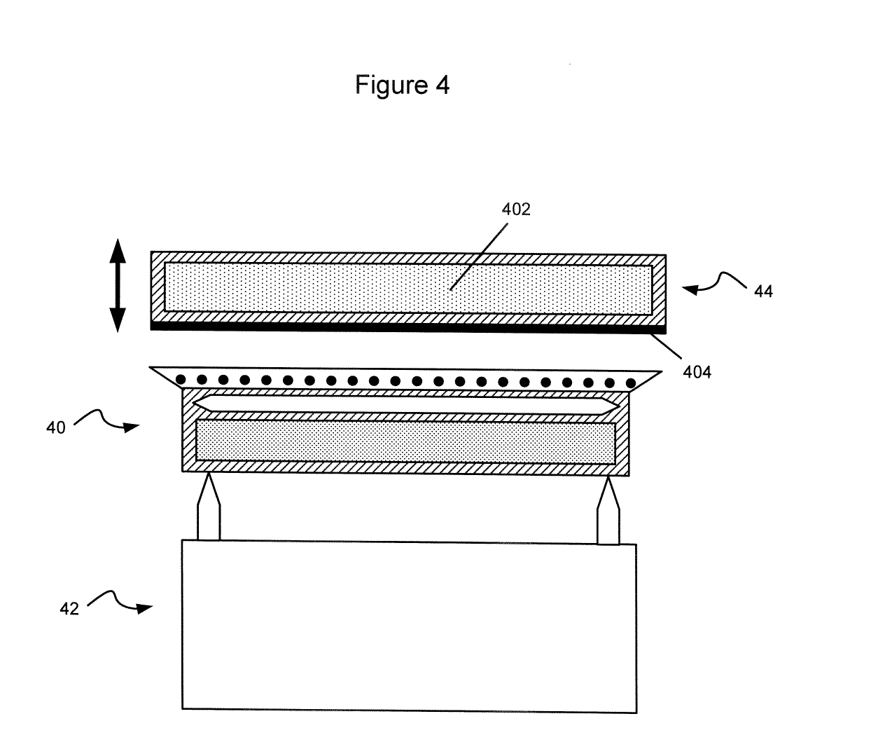

FIG. 4 shows a block diagram illustrating an exemplary method for pre-chilling a platen 40 in accordance with an embodiment of the present disclosure. The platen 40 may be same as or similar to the platen 30 shown in FIG. 3. The platen 40 may be thermally isolated from its base 42.

To pre-chill the platen 40, a cooling chuck 44 may be brought into direct thermal contact with the platen 40. The cooling chuck 44 may comprise a surface layer 404 which contains or is made from a material (e.g., silicon) that allows the cooling chuck 44 to be electrostatically clamped onto the platen 40. The cooling chuck 44 may have a relatively large heat capacity compared to the platen 40. The cooling chuck 44 may comprise a cold reservoir 402 that further enhances the cooling power of the cooling chuck 44. If a pre-heated platen 40 is desired, the cold reservoir 402 may be replaced by a heating element for pre-heating purposes.

The cooling chuck 44 may be located within a same wafer end-station (not shown) as the platen 40. According to one embodiment, the cooling chuck 44 may be pre-chilled with a coolant, a built-in refrigeration unit, and/or Peltier devices. The cooling chuck 44 may be held in a fixed position, and, prior to ion implantation, the platen 40 may be driven to mate with the surface layer 404 of the cooling chuck 44. Alternatively, the cooling chuck 44 may be pre-chilled at a cooling station (not shown) and then transferred to a position to engage with the platen 40. After the platen 40 has been cooled to a desired temperature, it may then be disengaged from the cooling chuck 44.

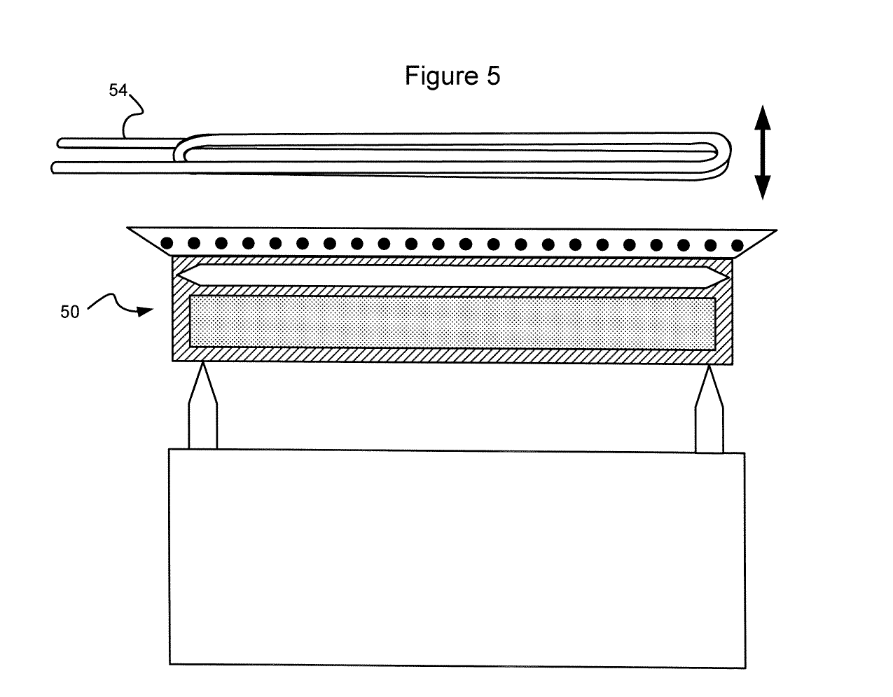

FIG. 5 shows a block diagram illustrating another exemplary method for pre-chilling a platen 50 in accordance with an embodiment of the present disclosure. In this embodiment, the platen 50 may be pre-conditioned to a desired temperature with an active cooling/heating element. For example, to pre-chill the platen 50, a cooling loop 54 may be brought into thermal contact with the platen 50. A coolant may be circulated through the cooling loop 54 to chill the platen 50 to the desired low temperature. If the platen 50 needs to be pre-heated, a heater head (not shown) may be brought into thermal contact with the platen 50. In order for the platen 50 to cool down or heat up quickly enough, a mechanism (not shown) such as a gas interface may be implemented to ensure an adequate thermal conduction between the platen 50 and the cooling loop 54 or the heater head.

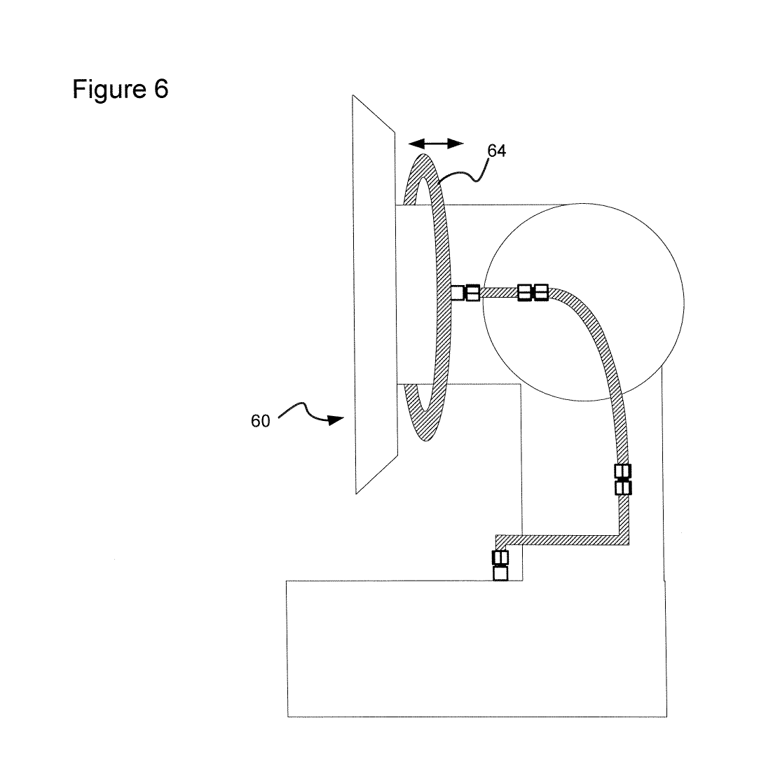

FIG. 6 shows a block diagram illustrating yet another exemplary method for pre-chilling a platen 60 in accordance with an embodiment of the present disclosure. In this preferable embodiment, a cooling loop 64 may be brought into thermal contact with a backside of the platen 60. A coolant may be circulated through the cooling loop 64 to chill the platen 60 to a desired low temperature. In order for the platen 60 to cool down quickly enough, a mechanism (not shown) such as a gas interface may be implemented to ensure an adequate thermal conduction between the platen 60 and the cooling loop 64.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A wafer support assembly for low-temperature ion implantation comprising:
a base; and
a platen configured to mount to the base via one or more low-thermal-contact members, wherein the platen has a heat capacity larger than that of a wafer mounted thereon, such that, if pre-chilled to a predetermined temperature, the platen causes the wafer to stay within a range of the predetermined temperature during ion implantation.

2. The wafer support assembly according to claim 1, wherein the platen comprises a thermal reservoir containing one or more coolants with a desired mass and heat capacity.

3. The wafer support assembly according to claim 2, wherein the one or more coolants comprise a phase-change material that maintains a constant temperature during a phase change.

4. The wafer support assembly according to claim 2, wherein the platen further comprises an electrostatic clamp to secure the wafer onto the platen.

5. The wafer support assembly according to claim 1, wherein the platen further comprises a gas break, and wherein a gas pressure within the gas break is adjustable to change a thermal conductivity between the platen and the wafer.

6. The wafer support assembly according to claim 1, wherein the platen further comprises cooling channels through which one or more coolants are circulated to cool the platen.

7. The wafer support assembly according to claim 1, further comprising:
a mechanism to bring a pre-chilled chuck into thermal contact with the platen to cool the platen.

8. The wafer support assembly according to claim 1, further comprising:
a mechanism to bring a cooling loop into thermal contact with the platen to cool the platen.

9. The wafer support assembly according to claim 1, wherein the wafer is pre-chilled together with the platen to the predetermined temperature.

10. A method for low-temperature ion implantation comprising the steps of:
pre-chilling a platen to a predetermined temperature;
mounting a wafer onto the pre-chilled platen, wherein the pre-chilled platen has a heat capacity larger than that of the wafer; and
performing ion implantation on the wafer, wherein the pre-chilled platen causes the wafer to remain within a range of the predetermined temperature.

11. The method according to claim 10, further comprising:
pre-chilling one or more coolants in a thermal reservoir located within the platen.

12. The method according to claim 11, further comprising:
pre-chilling a phase-change material in the thermal reservoir such that the wafer is maintained at an iso-thermal temperature during ion implantation.

13. The method according to claim 10, wherein the platen further comprises a gas break, and the method further comprising:
adjusting a gas pressure within the gas break to change a thermal conductivity between the platen and the wafer.

14. The method according to claim 13, wherein the wafer is monitored for temperature changes and the gas pressure within the gas break is adjusted to keep the wafer within a desired temperature range.

15. The method according to claim 10, further comprising:
pausing the ion implantation;
pre-chilling the platen; and
resuming the ion implantation on the wafer.

16. The method according to claim 10, wherein the platen is pre-chilled by circulating one or more coolants through cooling channels in the platen.

17. The method according to claim 10, wherein the wafer is continuously cooled by circulating one or more coolants through cooling channels in the platen.

18. The method according to claim 10, further comprising:
bringing a pre-chilled chuck into thermal contact with the platen to cool the platen.

19. The method according to claim 10, further comprising:
bringing a cooling loop into thermal contact with the platen to cool the platen.

20. The method according to claim 10, further comprising:
pre-chilling the wafer together with the platen to the predetermined temperature.

21. A wafer support assembly for wafer temperature control during ion implantation, the wafer support assembly comprising:
a base; and
a platen configured to mount to the base via one or more low-thermal-contact members, wherein the platen has a heat capacity larger than that of a wafer mounted thereon, such that, if pre-conditioned to a predetermined temperature, the platen causes the wafer to stay within a range of the predetermined temperature during ion implantation.
